(19) United States
(12) Patent Application Publication
(10) Pub. No.: US 2007/0160261 A1
(43) Pub. Date: Jul. 12, 2007

(54) Watermark detection by correlation shape analysis

(75) Inventor: David K. Robert, Crawley (GB)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 10/597,820

(22) PCT Filed: Feb. 8, 2005
(86) PCT No.: PCT/IB05/50495

§ 371 Date: Aug. 9, 2006

(30) Foreign Application Priority Data
Feb. 14, 2004 (GB) 0403330.4

(51) Int. Cl. G06K 9/00

(52) U.S. Cl. 382/100

(57) ABSTRACT

A watermark detector (100) detects a watermark in an information signal. The information signal is correlated with an expected watermark (Wi) for each of a plurality of relative positions of the information signal with respect to the watermark to derive a set of correlation results (64). The correlation results (64) are analysed to identify a cluster of correlation results which exceed a threshold value, the cluster representing a possible correlation peak. Where multiple clusters are identified, the most likely cluster is selected for further processing while other results are discarded. The cluster of results can identify a correlation peak which has become smeared due to lossy processing during distribution of the information signal.

This invention relates to detecting a watermark in an information signal.

Watermarking is a technique in which a label of some kind is added to an information signal. The information signal to which the watermark is added can represent a data file, a still image, video, audio or any other kind of media content. The label is embedded in the information signal before the information signal is distributed. The label is usually added in a manner which is imperceptible under normal conditions, in order that it does not degrade the information signal, e.g. a watermark added to an audio file should not be audible under normal listening conditions. However, the watermark should be robust enough to remain detectable even after the information signal has undergone the normal processes during transmission, such as coding or compression, modulation and so on.

Many watermarking schemes employ correlation as a detection technique, with a signal under test being correlated with a signal containing a known watermark. In these systems, the presence of a watermark is indicated by one or more peaks in the correlation results. The paper “A Video Watermarking System for Broadcast Monitoring”, Ton Kalker et al., Proceedings of the SPIE, Bellingham, Va. vol. 3657, 25 Jan. 1999, p. 103-112, describes a scheme for detecting the presence of a watermark in broadcast video content.

In most applications the watermarked content will undergo various processing operations between the point at which a watermark is embedded in the content and the point at which the presence of the watermark is detected. A common example of content processing is lossy compression, such as MPEG coding. Typically, processing will lower the correlation peaks that would normally be expected to occur during the watermark detection process. Thus, the performance of a watermark detection technique based on finding correlation peaks is considerably reduced.

The present invention seeks to provide an improved way of detecting a watermark in an information signal.

Accordingly, a first aspect of the present invention provides a method of detecting a watermark in an information signal, comprising:

deriving a set of correlation results by correlating the information signal with a watermark for each of a plurality of relative positions of the information signal with respect to the watermark;

analysing the set of correlation results to identify a cluster of correlation results which exceed a predetermined threshold value, the cluster representing a possible correlation peak.

It has been found that the processing which many information signals experience can have the effect of smearing a correlation peak when it is attempted to detect the watermark by correlation. By identifying clusters of suitably sized correlation results, it is possible to identify watermarked content, even where processing or other attacks have degraded the quality of the watermark, reducing the height of the correlation peak below the threshold normally used for detection. This improves performance of the watermark detector and extraction of the watermark payload.

The ability to detect watermarks that are only weakly present in an item of media content also provides the option of allowing the watermark to be more weakly embedded in the content, thereby reducing its visibility under inspection by potential fraudulent parties or reducing it's perceptibility under normal viewing conditions.

Preferably, if the step of analysing the set of correlation results identifies a plurality of clusters of correlation results, the method further comprises processing the clusters to identify the cluster which is most likely to represent the true correlation peak. This processing can be restricted to the clusters of correlation results, rather than the entire set of correlation results. This can considerably reduce the amount of computation required, leading to faster analysis and simpler (and cheaper) detector requirements.

The cluster of correlation results, and their values, provides information about the shape of the correlation peak, which can be used to further improve performance of the watermark detector. The shape of the peak can be better understood by viewing the correlation results in the form of a graph, with the correlation value being plotted as height above a base line of the graph.

The functionality described here can be implemented in software, hardware or a combination of these. Accordingly, another aspect of the invention provides software for performing the method.

It will be appreciated that software may be installed on the host apparatus at any point during the life of the equipment. The software may be stored on an electronic memory device, hard disk, optical disk or other machine-readable storage medium. The software may be delivered as a computer program product on a machine-readable carrier or it may be downloaded directly to the apparatus via a network connection.

Further aspects of the invention provide a watermark detector for performing any of the steps of the method and an apparatus for presenting an information signal which responds to the output of the watermark detector.

While the described embodiment makes reference to processing an image or video signal, it will be appreciated that the information signal can be data representing audio or any other kind of media content.

Embodiments of the present invention will now be described, by way of example only, with reference to the accompanying drawings, in which:

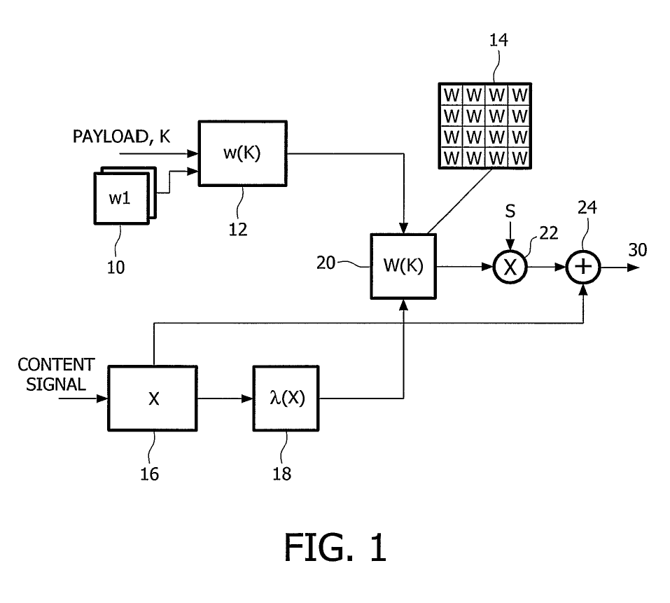

FIG. 1 shows a known way of embedding a watermark in an item of content;

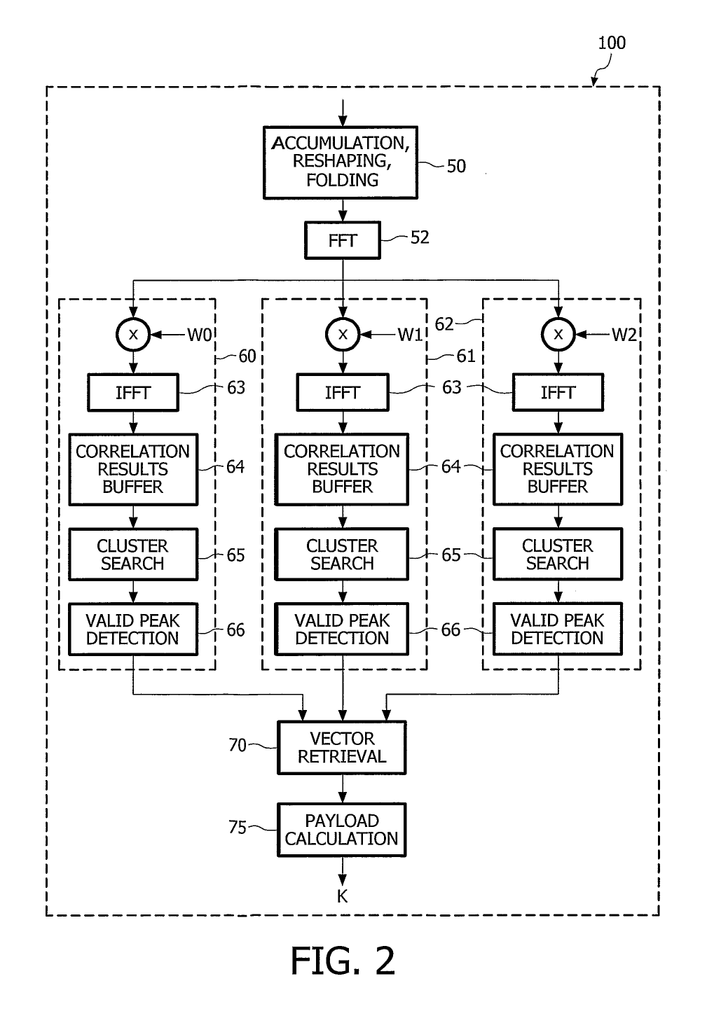

FIG. 2 shows an arrangement for detecting the presence of a watermark in an item of content;

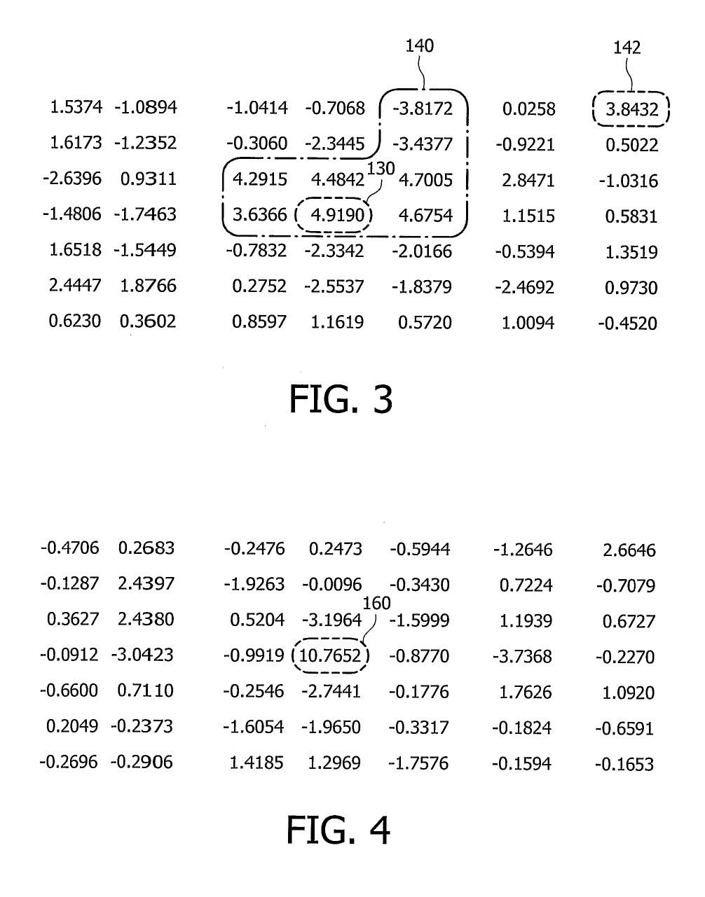

FIGS. 3 and 4 show tables of correlation results for use in the detection method;

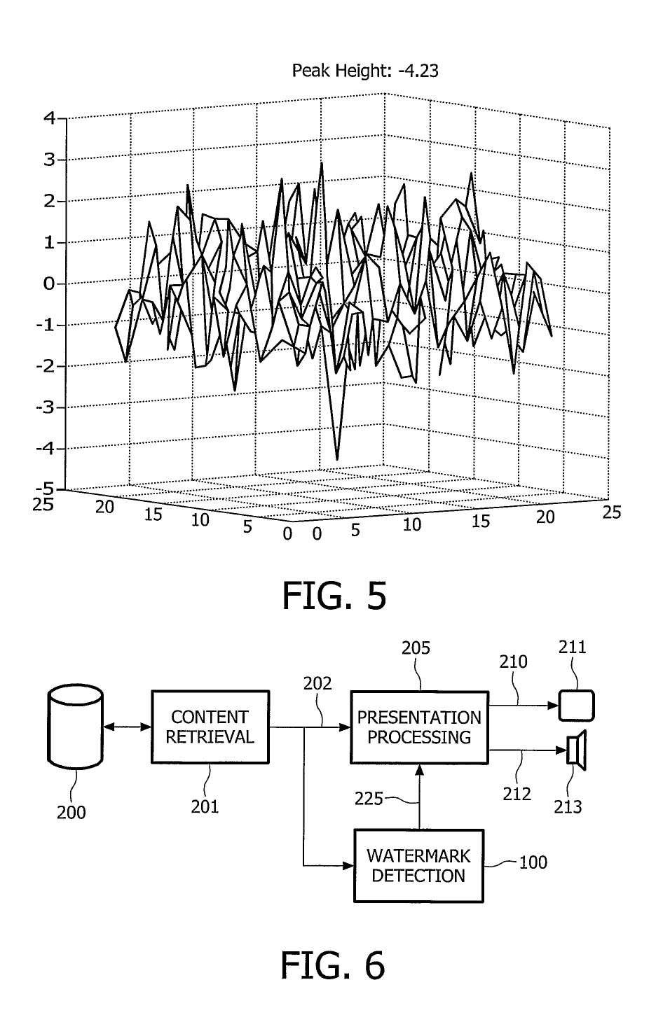

FIG. 5 shows a set of correlation results data plotted as a graph to show peak shape; and,

FIG. 6 shows apparatus for presenting content which embodies the watermark detection apparatus.

By way of background, and to understand the invention, a process of embedding a watermark will be briefly described, with reference to FIG. 1. A watermark pattern w(K) is constructed using one or more basic watermark patterns w. Where a payload of data is to be carried by the watermark, a number of basic watermark patterns are used. The watermark pattern w(K) is chosen according to the payload—a multi-bit code K—that is to be embedded. The code is represented by selecting a number of the basic patterns w and offsetting them from each other by a particular distance and direction. The combined watermark pattern w(K) represents a noise pattern which can be added to the content. The watermark pattern w(K) has a size of M×M bits and is typically much smaller than the item of content. Consequently, the M×M pattern is repeated (tiled) 14 into a larger pattern which matches the format of the content data. In the case of an image, the pattern w(K) is tiled 14 such that it equals the size of the image with which it will be combined.

A content signal is received and buffered 16. A measure of local activity λ(X) in the content signal is derived 18 at each pixel position. This provides a measure for the visibility of additive noise and is used to scale the watermark pattern W(K). This prevents the watermark from being perceptible in the content, such as areas of equal brightness in an image. An overall scaling factor s is applied to the watermark at multiplier 22 and this determines the overall strength of the watermark. The choice of s is a compromise between the degree of robustness that is required and the requirement for how perceptible the watermark should be. Finally, the watermark signal W(K) is added 24 to the content signal. The resulting signal, with the watermark embedded within it, will then be subject to various processing steps as part of the normal distribution of that content.

FIG. 2 shows a schematic diagram of a watermark detector 100. The watermark detector receives content that may be watermarked. In the following description the content is assumed to be images or video content. Watermark detection may be performed for individual frames or for groups of frames. Accumulated frames are partitioned into blocks of size M×M (e.g. M=128) and then folded into a buffer of size M×M. These initial steps are shown as block 50. The data in the buffer is then subject to a Fast Fourier Transform 52. The next step in the detection process determines the presence of watermarks in the data held in the buffer. To detect whether or not the buffer includes a particular watermark pattern W, the buffer contents and the expected watermark pattern are subjected to correlation. As the content data may include multiple watermark patterns, a number of parallel branches 60, 61, 62 are shown, each one performing correlation with one of the basic watermark patterns W0, W1, W2. The correlation values for all possible shift vectors of a basic pattern Wi are simultaneously computed. The basic watermark pattern Wi (i=0,1,2) is subjected to a Fast Fourier Transform (FFT) before correlation with the data signal. The set of correlation values is then subject to an inverse Fast Fourier transform 63. Full details of the correlation operation is described in U.S. Pat. No. 6,505,223 B1.

The Fourier coefficients used in the correlation are complex numbers, with a real part and an imaginary part, representing a magnitude and a phase. It has been found that the reliability of the detector is significantly improved if the magnitude information is thrown away and the phase is considered only. A magnitude normalization operation can be performed after the pointwise multiplication and before the inverse Fourier Transform 63. The operation of the normalization circuit comprises pointwise dividing each coefficient by its magnitude. The above technique is generally referred to as Symmetrical Phase Only Matched Filtering (SPOMF).

The set of correlation results from the above processing are stored in a buffer 64 and then analysed by a cluster searching operation 65. Watermarked content is indicated by the presence of peaks in the correlation results data. The peaks are highly unlikely to occur in pure Gaussian noise. The set of correlation results are examined to identify peaks that might be due to a watermark. The presence of a watermark may be indicated by a sharp, isolated peak of significant height, although most isolated peaks tend to represent spurious matches due to noise. It is more likely that a peak due to a watermark will be smeared over several adjacent positions in the correlation results. The algorithm described below identifies potential watermark correlation peaks by searching for clusters of closely spaced points of significant height. The aim is to find a cluster of points with an extremely low likelihood of occurring. The clustering algorithm forms a number of clusters of points, any of which may correspond to the true correlation peak. The likelihoods of these clusters are compared, and the cluster with the lowest likelihood is assumed to be the wanted correlation peak. The algorithm comprises the following steps:

1. Set a threshold value and find all points in the correlation data which have an absolute value above this threshold value. All points meeting this criteria are stored in a list—ptsAboveThresh. A suggested threshold value is 3.3σ (σ=standard deviation of the results in buffer 64) although this can be set to any preferred value. A preferred range is 2.5-4σ. If the threshold value is set too low a large number of points, which do not correspond to the presence of a watermark, will be stored in the list. Conversely, if the value is set too high there is a risk that points corresponding to a valid, but smeared, peak will not be added to the list.

2. Find the point with the highest absolute value.

3. Form candidate clusters, i.e. clusters of correlation points. Candidate clusters are formed by collecting points that not only have ‘significant’ value (a value greater than the threshold), but which are also located very close to at least one other point of significant value. This is achieved as follows:
(i) Remove the first point from the ptsAboveThresh list and enter it as the first point p of a new cluster;
(ii) Search ptsAboveThresh for points that are within a distance d of point p. Remove all such points from the ptsAboveThresh list, and add them to the cluster;
(iii) Take the next point in the cluster as the current point p. Repeat step (ii) in order to add to the cluster all points in ptsAboveThresh that are within distance d of the new point p.
(iv) Repeat Step (iii) until ptsAboveThresh has been processed for all points in the cluster;
(v) If the resulting cluster consists of only a single point and that point is not equal to the highest peak found in Step 2 above, then discard this cluster;
(vi) Repeat Steps (i) to (v) until ptsAboveThresh is empty.

At the end of this procedure, all points originally entered into ptsAboveThresh in Step 1 above have been either:
assigned to a cluster containing other points from the ptsAboveThresh list that are close to it, or
discarded, as they have no neighbours of similar height, and are therefore not part of a cluster.

A cluster is only allowed to comprise a single point if that point has the largest absolute height of all the points in the correlation buffer. This prevents a sharp, unsmeared, correlation peak from being discarded, but prevents other isolated peaks, representing true noise, from being used.

A final stage—valid peak detection 66—determines which of the clusters of results is most likely to represent the true correlation peak due to the presence of a watermark. There are various ways of achieving this. One technique, which is described in a co-pending patent application, compares the shape of the cluster of results with stored data representing an expected peak shape. The comparison can be performed by a cross-correlation technique. Where there are several candidate clusters, the comparison is performed on each candidate cluster and the cluster exhibiting the closest match is selected as the one representing the true correlation peak.

FIGS. 3 and 4 show some example sets of correlation data of the type that would be calculated by the detector. In the set of data shown in FIG. 3 the values range between −3.8172 and 4.9190. It will be noted that watermarks can be embedded with negative amplitude. The highest value of 4.9190 is shown within box 130. Although this is below the typical detection threshold of 5, the highest value is surrounded by other correlation values of a similar value. This is indicative of a peak which has been smeared by processing during the distribution chain. Following the procedure described above, and setting a threshold T of 3.3 and a distance of 1, it can be found that the correlation values within ring 140 meet this criteria. It should be noted that the threshold is an absolute value and so the results −3.8172 and −3.4377 are also included. Working through the process, the results of significant value are all located alongside each other. An isolated point, shown as point 142, is discarded during the process as it has no neighbouring points above the threshold, and point 142 is not, itself, the highest point within the buffer.

Looking at the data shown in FIG. 4, the values range between −3.7368 and 10.7652. Applying the same detection criteria, only one point 160 exceeds the threshold. The value of this point clearly exceeds the threshold and thus is considered to be a valid peak. From inspecting the neighbouring values, it can be seen that this represents a sharp correlation peak.

Once a valid peak has been identified in one or more sets of correlation data, matching of the different sets of data occurs to find a vector between the watermark patterns, i.e. to identify the distance and direction by which the different patterns w0, w1, w2 are offset from one another. In a final step 75, the vectors identified in the preceding step 70 are converted into a code, representing the payload of the watermark.

To illustrate what is meant by the shape of a correlation peak, FIG. 5 shows a set of correlation results data plotted as a graph. In this example, a peak of −4.23 is shown.

If it is known that a content signal is likely to have a particular correlation peak shape, the threshold used at stage 56 can be varied accordingly. For example, if it is known that the correlation peak will be high and sharp, the threshold can be set high whereas if it is known that the peak may be flattened, the threshold can be lowered so as not to prevent any correlation results representing the true peak from being excluded. Processing such as lossy compression, modulation and coding can flatten or otherwise distort the shape of the correlation peak.

The embedded information represented as payload code K may identify, for example, the copy-right holder or a description of the content. In DVD copy-protection, it allows material to be labelled as ‘copy once’, ‘never copy’, ‘no restriction’, ‘copy no more’, etc. FIG. 6 shows an apparatus for retrieving and presenting a content signal which is stored on a storage medium 200, such as an optical disk, memory device or hard disk. The content signal is retrieved by a content retrieval unit 201. The content signal 202 is applied to a processing unit 205, which decodes the data and renders it for presentation 211, 213. The content signal 202 is also applied to a watermark detection unit 220 of the type previously described. The processing unit 205 is arranged so that it is only permitted to process the content signal if a predetermined watermark is detected in the signal. A control signal 225 sent from the watermark detection unit 220 informs the processing unit 205 whether processing of the content should be allowed or denied, or informs the processing unit 205 of any copying restrictions associated with the content. Alternatively, the processing unit 205 can be arranged so that it is only permitted to process the content signal if a predetermined watermark is not detected in the signal.

In the above description, a set of three watermarks have been considered. However, it will be appreciated that the technique can be applied to find a correlation peak in content data carrying only a single watermark, or to content data carrying any number of multiple watermarks.

In the description above, and with reference to the Figures, there is described a watermark detector 100 which detects a watermark in an information signal. The information signal is correlated with an expected watermark Wi for each of a plurality of relative positions of the information signal with respect to the watermark to derive a set of correlation results 64. The correlation results 64 are analysed to identify a cluster of correlation results which exceed a threshold value, the cluster representing a possible correlation peak. Where multiple clusters are identified, the most likely cluster is selected for further processing while other results are discarded. The cluster of results can identify a correlation peak which has become smeared due to lossy processing during distribution of the information signal.

1. A method of detecting a watermark in an information signal, comprising:
deriving a set of correlation results (64) by correlating the information signal with a watermark (Wi) for each of a plurality of relative positions of the information signal with respect to the watermark; and
analysing (65) the set of correlation results to identify a cluster of correlation results which exceed a threshold value, the cluster representing a possible correlation peak.

2. A method according to claim 1 wherein the step of analysing (65) the set of results comprises determining all correlation results in the set which exceed the threshold value and then determining which of those correlation results are located within a predetermined distance of each other.

3. A method according to claim 1 wherein, if the step of analysing the set of correlation results identifies an isolated correlation result which exceeds the threshold value, the method further comprises determining if that isolated correlation result is the correlation result having the highest value within the set of correlation results.

4. A method according to claim 1 wherein, if the step of analysing the set of correlation results identifies a plurality of clusters of correlation results, the method further comprises processing (66) the clusters to identify the cluster which is most likely to represent the true correlation peak.

5. A method according to claim 4 wherein the processing (66) comprises comparing the shape of the cluster of correlation results with stored shape information and selecting the cluster with the best match to the stored shape information.

6. A method according to claim 4 wherein all clusters, other than the one selected as being the most likely, are discarded.

7. A method according to claim 1 wherein the threshold value is varied according to an expected correlation peak shape and/or height.

8. (canceled)

9. A watermark detector for detecting a watermark in an information signal, comprising:
means for deriving a set of correlation results by correlating the information signal with a watermark for each of a plurality of relative positions of the information signal with respect to the watermark; and,
means for analysing the set of correlation results to identify a cluster of correlation results which exceed a predetermined threshold value, the cluster representing a possible correlation peak.

10. (canceled)

12. Apparatus for presenting an information signal comprising means for disabling operation of the apparatus in dependence on the presence of a valid watermark in the information signal, wherein the apparatus comprises a watermark detector according to claim 9.

13. A watermark detector for detecting a watermark in an information signal, comprising:
a processor for deriving a set of correlation results by correlating the information signal with a watermark for each of a plurality of relative positions of the information signal with respect to the watermark; said processor analyzing the set of correlation results to identify a cluster of correlation results which exceed a predetermined threshold value, the cluster representing a possible correlation peak.
